(19) United States
(12) Patent Application Publication
(10) Pub. No.: US 2022/0207464 A1
(43) Pub. Date: Jun. 30, 2022

(54) PROCESS, SYSTEM, AND DEVICE FOR DETERMINING A RELATED PRODUCT

(71) Applicant: Cree, Inc., Durham, NC (US)

(72) Inventors: David Skinner, Gun Barrel City, TX (US); Mitchell Rothrock, Cary, NC (US)

(21) Appl. No.: 17/138,193

(22) Filed: Dec. 30, 2020

(51) Int. Cl. G06Q 10/08; G06Q 90/00

(52) U.S. Cl. CPC G06Q 10/087; G06Q 90/00

(57) ABSTRACT

A method for related product identification includes receiving input data that includes a reference device data input and a parameter input. The method may further include determining at least one related product that matches the reference device data input and the parameter input with the at least one processor; and outputting with the at least one processor the at least one related product that matches the reference device data input and the parameter input.

### BACKGROUND OF THE DISCLOSURE

Manufacturing typically includes obtaining various products from multiple suppliers to be combined with other products to produce a desired end product. However, when selecting a particular product from the multiple suppliers, finding the closest match from the multiple suppliers, also known as cross-referencing, can be a painstaking process, especially when desired features or parameters of a product are substantially similar.

Accordingly, what is needed is a process, system and/or device for more accurately determining products from the multiple suppliers substantially matching various desired parameters. Additionally, what is needed is a process, system and/or device for more quickly determining products from the multiple suppliers substantially matching various desired features or parameters.

### SUMMARY OF THE DISCLOSURE

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One aspect includes a method for related product identification that includes receiving input data that that includes a reference device data input and a parameter input; determining at least one related product that matches the reference device data input and the parameter input; and outputting the at least one related product that matches the reference device data input and the parameter input.

One aspect includes a method for related product identification that includes receiving input data that that includes a reference device data input and a parameter input; and determining at least one related product that is closest to the reference device data input and the parameter input.

One aspect includes a system for related product identification that includes the system configured to receive a reference device data input and a parameter input; the system configured to determine at least one related product that matches the reference device data input and the parameter input; and the system further configured to output the at least one related product that matches the reference device data input and the parameter input.

One aspect includes a system for related product identification that includes a system configured to receive a reference device data input and a parameter input; and the system configured to determine at least one related product that is closest to the reference device data input and the parameter input.

Additional features, advantages, and aspects of the disclosure may be set forth or apparent from consideration of the following detailed description, drawings, and claims. Moreover, it is to be understood that both the foregoing summary of the disclosure and the following detailed description are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate aspects of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1 illustrates a first display rendering for data input according to the disclosure.

FIG. 2 illustrates a second display rendering for data input according to the disclosure.

FIG. 3 illustrates a third display rendering for data input according to the disclosure.

FIG. 4 illustrates a fourth display rendering for data input according to the disclosure.

FIG. 5 illustrates a fifth display rendering for data output according to the disclosure.

FIG. 6 illustrates another first display rendering for data input according to the disclosure.

FIG. 7 illustrates another fifth display rendering for data output according to the disclosure.

FIG. 8 illustrates a process according to the disclosure.

FIG. 9 illustrates a system according to the disclosure.

FIG. 10 illustrates a device according to the disclosure.

### DETAILED DESCRIPTION OF THE DISCLOSURE

The aspects of the disclosure and the various features and advantageous details thereof are explained more fully with reference to the non-limiting aspects and examples that are described and/or illustrated in the accompanying drawings and detailed in the following description. It should be noted that the features illustrated in the drawings are not necessarily drawn to scale, and features of one aspect may be employed with other aspects as the skilled artisan would recognize, even if not explicitly stated herein. Descriptions of well-known components and processing techniques may be omitted so as to not unnecessarily obscure the aspects of the disclosure. The examples used herein are intended merely to facilitate an understanding of ways in which the disclosure may be practiced and to further enable those of skill in the art to practice the aspects of the disclosure. Accordingly, the examples and aspects herein should not be construed as limiting the scope of the disclosure, which is defined solely by the appended claims and applicable law. Moreover, it is noted that like reference numerals represent similar parts throughout the several views of the drawings.

When selecting a product, finding the closest match from multiple suppliers (cross-referencing) can be a painstaking process, especially when two products have features and/or parameters that are substantially similar or different. The disclosed process, system, and device may enable a user to quickly find the closest product match, as well as at least the next closest product match with a parameter less than and/or a parameter greater than the desired value. Moreover, the disclosed process, system, and device may enable a user to quickly find the closest product match, as well as at least the next closest product match with a parameter less than the desired value and the next closest product match with a parameter greater than the desired value.

A further aspect of the disclosure is a process, system, and device that has the ability to update product data dynamically by capturing data directly from manufacturers' parametric tables, graphics, text, and/or the like on their own websites, and using an algorithm to automatically choose the right devices to recommend. Every time a manufacturer releases a new product, makes any changes to an existing product, and/or the like, the disclosed cross-reference process, system, and device collect the most up-to-date product data information and accordingly may choose the right comparable products with the most up-to-date information.

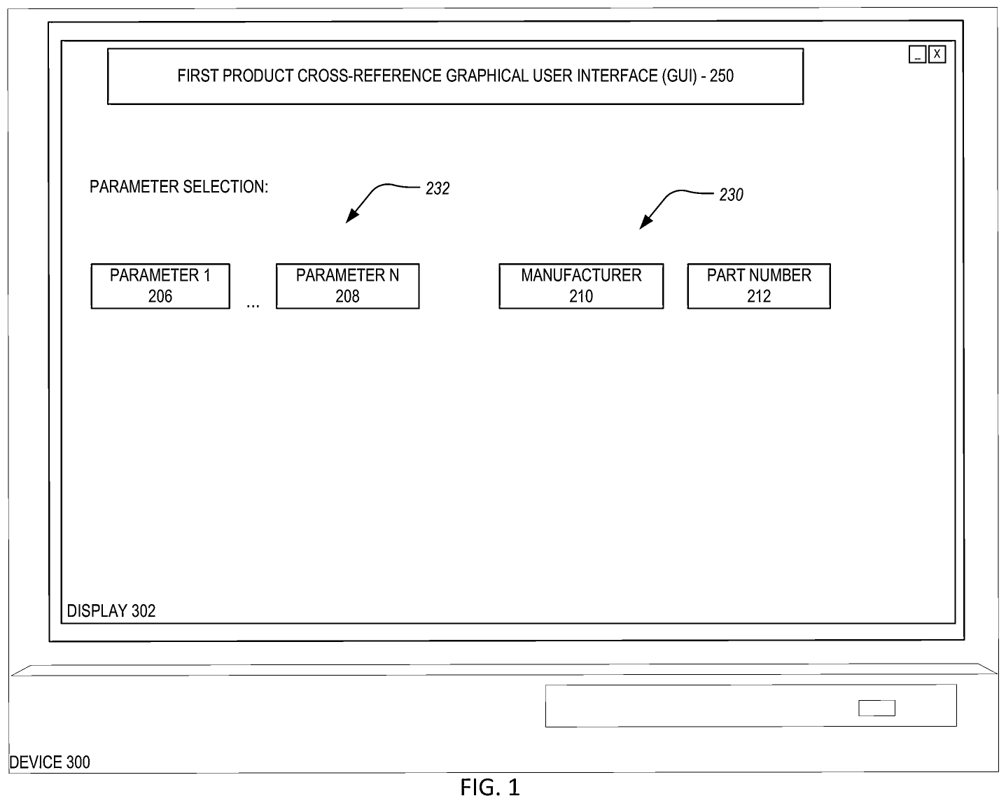

FIG. 1 illustrates a first display rendering for data input according to the disclosure.

In particular, FIG. 1 illustrates a first product cross-reference graphical user interface (GUI) 250 that may include a reference device data input portion 230 for display on a display 302 of a device 300. The first product cross-reference graphical user interface (GUI) 250 may additionally or alternatively include a parameter input portion 232 for display on the display 302 of the device 300. With further reference to FIG. 1, the first product cross-reference graphical user interface (GUI) 250 is merely exemplary of a possible layout, possible features, and/or the like. The disclosure contemplates that the first product cross-reference graphical user interface (GUI) 250 may be implemented numerous other ways. Moreover, the disclosure contemplates that any one of the features illustrated in any one of FIGS. 1-7 may be included in any of the other aspects illustrated in FIGS. 1-7.

The reference device data input portion 230 may include an input portion to receive keyed in data, data selection by drop-down boxes, data selection by selection from a list, data selection by a drop-down list, data selection by radio buttons, input data by voice recognition, input data by image, input data by machine-readable code, and/or the like. In one aspect, the keyed in data may automatically populate and/or provide suggested input based on a partial input. In this regard, the reference device data input portion 230 may be configured to receive an input regarding reference device data for determining at least in part a related product.

The parameter input portion 232 may include an input portion to receive keyed in data, data selection by drop-down boxes, data selection by selection from a list, data selection by a drop-down list, data selection by radio buttons, input data by voice recognition, input data by image, input data by machine-readable code, and/or the like. In one aspect, the keyed in data may automatically populate and/or provide suggested input based on a partial input. In this regard, the parameter input portion 232 may be configured to receive an input regarding reference device parameter for determining at least in part a related product.

In one aspect, the parameter input portion 232 may include a first parameter input 206, a second parameter input, . . . an Nth parameter input 208, and/or the like for display on the display 302 of the device 300. In this regard, the parameter input portion 232 may be configured to receive an input regarding a parameter for determining at least in part a related product. More specifically, the parameter may include one or more parameters, one or more features, one or more characterizations, and/or the like that may be utilized to beneficially and more accurately determine one or more related products.

The reference device data input portion 230 may include a manufacturer input 210, a part number input 212, a device type input (not shown) and/or the like. In one aspect, the manufacturer input 210 may include an input portion to receive keyed in data, data selection by drop-down boxes, data selection by selection from a list, data selection by a drop-down list, data selection by radio buttons, input data by voice recognition, input data by image, input data by machine-readable code, and/or the like. In one aspect, the keyed in data may automatically populate and/or provide suggested input based on a partial input. In this regard, the manufacturer input 210 may be configured to receive an input regarding a manufacturer name for determining at least in part a related product.

In one aspect, the part number input 212 may include an input portion to receive keyed in data, data selection by drop-down boxes, data selection by selection from a list, data selection by a drop-down list, data selection by radio buttons, input data by voice recognition, input data by image, input data by machine-readable code, and/or the like. In one aspect, the keyed in data may automatically populate and/or provide suggested input based on a partial input. In this regard, the part number input 212 may be configured to receive an input regarding a part number or other part identifier for determining at least in part a related product.

In one aspect, the device type input may include an input portion to receive keyed in data, data selection by drop-down boxes, data selection by selection from a list, data selection by a drop-down list, data selection by radio buttons, input data by voice recognition, input data by image, input data by machine-readable code, and/or the like. In one aspect, the keyed in data may automatically populate and/or provide suggested input based on a partial input. In this regard, the device type input may be configured to receive an input regarding a device type for determining at least in part a related product.

The device type might be any type of device in which it is desired to find a corresponding one or more cross-reference products, related products, and/or the like. In particular aspects, the device type may be any type of semiconductor device, transistor, power device, power module, any type of electrical component that may include resistors, capacitors, inductors, and/or the like. In this regard, the device types may include but are not limited to a Metal Semiconductor Field-Effect Transistor (MESFET), a Metal Oxide Field Effect Transistor (MOSFET), a Junction Field Effect Transistor (JFET), a Bipolar Junction Transistor (BJT), an Insulated Gate Bipolar Transistor (IGBT), a high-electron-mobility transistor (HEMT), a metal insulator semiconductor FET (MISFET), a static induction transistor (SiT), a Thyristor, a Gate Turn-Off Thyristor (GTO), an Integrated Gate-Commutated Thyristor (IGCT), and/or the like. The term power device may refer to various forms of transistors and diodes designed for high voltages and currents. The transistors may be controllable switches allowing for unidirectional or bidirectional current flow (depending on device type) while the diodes may allow for current flow in one direction and may not controllable. The power module may implement a plurality of power devices that range in structure and purpose.

In one aspect, FIG. 1 illustrates the first product cross-reference graphical user interface (GUI) 250 that may include the reference device data input portion 230 that may include the manufacturer input 210, the part number input 212, a device type input, and/or the like and the first product cross-reference graphical user interface (GUI) 250 may include the parameter input portion 232 that may include the first parameter input 206, a second parameter input, . . . an Nth parameter input 208, and/or the like for display on the display 302 of the device 300.

The first product cross-reference graphical user interface (GUI) 250 may be generated by the device 300 and/or the first product cross-reference graphical user interface (GUI) 250 may be generated by the device 300 in response to the cross-reference system 400. With further reference to FIG. 1, the first product cross-reference graphical user interface (GUI) 250 is merely exemplary of a possible layout, possible features, and/or the like. The disclosure contemplates that first product cross-reference graphical user interface (GUI) 250 may be implemented numerous other ways.

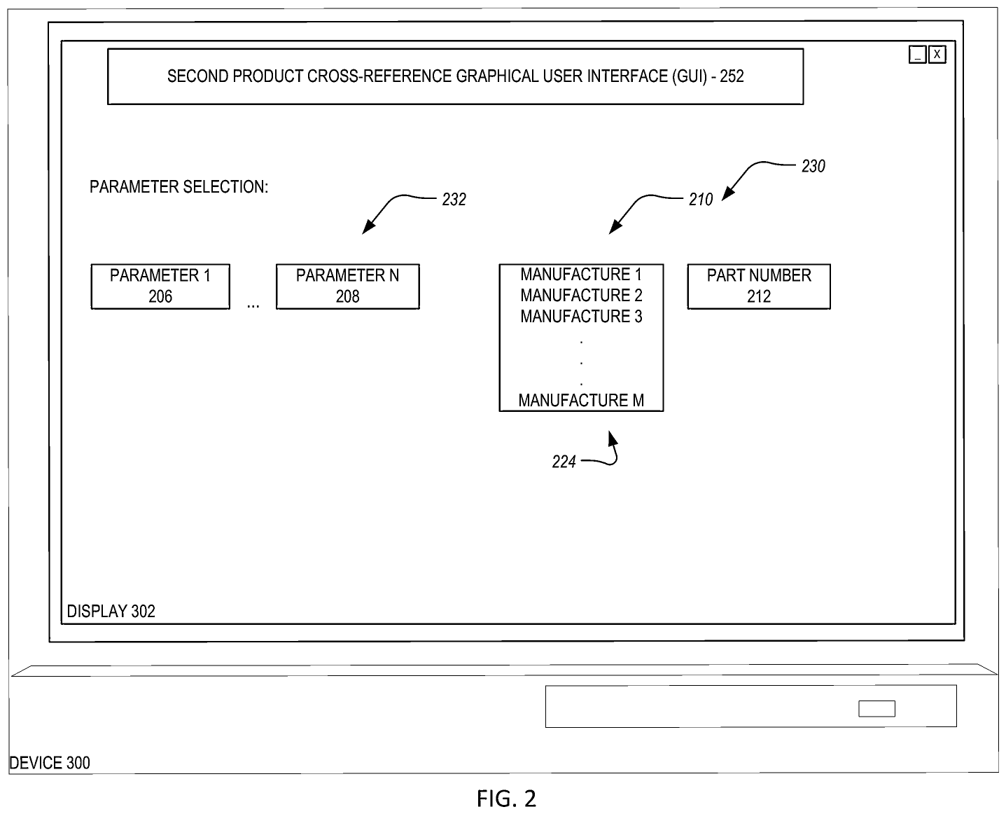

FIG. 2 illustrates a second display rendering for data input according to the disclosure.

In particular, FIG. 2 illustrates a second product cross-reference graphical user interface (GUI) 252 that may include, the reference device data input portion 230, the parameter input portion 232, the part number input 212, the first parameter input 206, the second parameter input, . . . the Nth parameter input 208, a device type input, and/or the like for display on the display 302 of the device 300. In one aspect, the second product cross-reference graphical user interface (GUI) 252 may display the reference device data input portion 230 that may include a listing of manufacturers 224 for selection by the user. For example, interaction with the manufacturer input 210 may generate the listing of manufacturers 224. In particular, interaction with the manufacturer input 210 may be provided to the device 300 and/or the cross-reference system 400. Thereafter, the device 300 and/or the cross-reference system 400 may provide corresponding data for generation of the listing of manufacturers 224. In this regard, manufacture 1 through manufacture M when implemented consistent with the disclosure may list actual manufacturer names.

The second product cross-reference graphical user interface (GUI) 252 may be generated by the device 300 and/or the second product cross-reference graphical user interface (GUI) 252 may be generated by the device 300 in response to the cross-reference system 400. With further reference to FIG. 2, the second product cross-reference graphical user interface (GUI) 252 is merely exemplary of a possible layout, possible features, and/or the like. The disclosure contemplates that the second product cross-reference graphical user interface (GUI) 252 may be implemented numerous other ways.

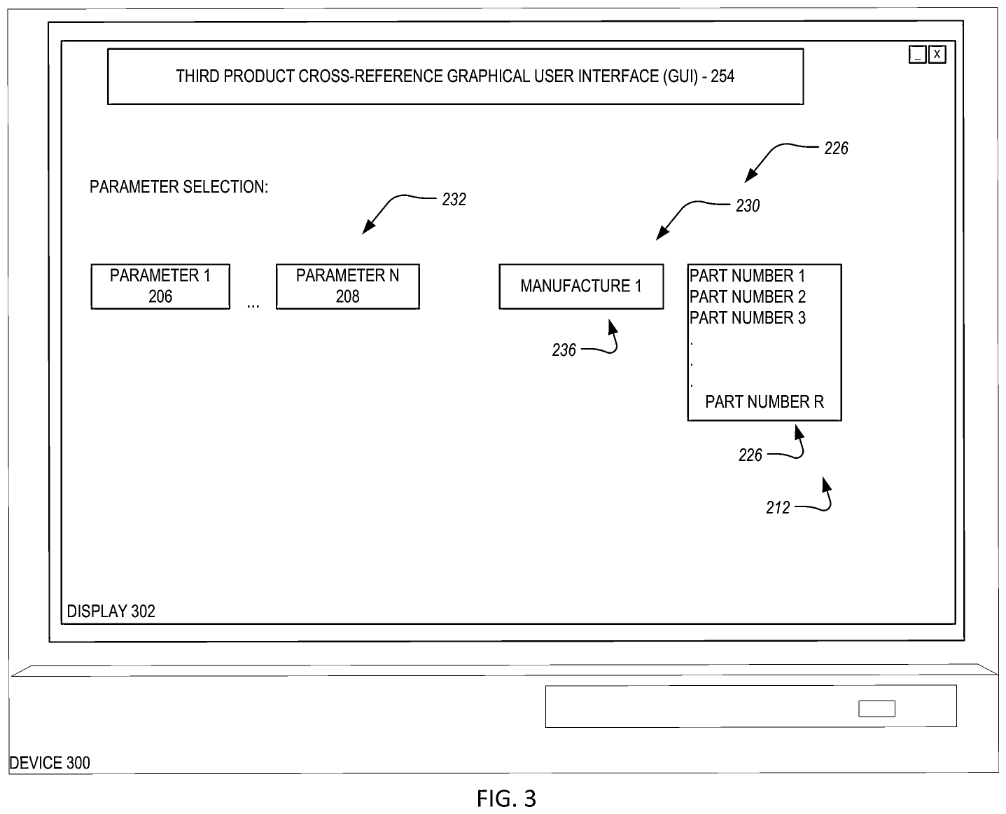

FIG. 3 illustrates a third display rendering for data input according to the disclosure.

In particular, FIG. 3 illustrates a third product cross-reference graphical user interface (GUI) 254 that may include the reference device data input portion 230, the parameter input portion 232, the part number input 212, the first parameter input 206, the second parameter input, . . . the Nth parameter input 208, a device type input, and/or the like for display on the display 302 of the device 300. In one aspect as illustrated, the third product cross-reference graphical user interface (GUI) 254 may include a selected one of the listing of manufacturers 236 as well as a listing of parts 226 for selection by the user. In particular, the third product cross-reference graphical user interface (GUI) 254 illustrates that the reference device data input portion 230 has been utilized to select manufacture 1. For example, interaction with the listing of manufacturers 224 may generate the selected one of the listing of manufacturers 236. In particular, interaction with the listing of manufacturers 224 may be provided to the device 300 and/or the cross-reference system 400. Thereafter, the device 300 and/or the cross-reference system 400 may provide corresponding data for generation of selected one of the listing of manufacturers 236. In this regard, manufacture 1 when implemented consistent with the disclosure may list an actual manufacturer name. Additionally, the third product cross-reference graphical user interface (GUI) 254 illustrates that the reference device data input portion 230 has been updated such that the part number input 212 may list part numbers associated with the selected one of the listing of manufacturers 236. In particular, the listing of parts 226 of the part number input 212 may list part number 1 through part number R. For example, the selected one of the listing of manufacturers 236 may be provided to the device 300 and/or the cross-reference system 400. Thereafter, the device 300 and/or the cross-reference system 400 may provide corresponding data for generation of the listing of parts 226. In this regard, part number 1 through part number R when implemented consistent with the disclosure may list an actual part numbers or other identifiers.

The third product cross-reference graphical user interface (GUI) 254 may be generated by the device 300 and/or the third product cross-reference graphical user interface (GUI) 254 may be generated by the device 300 in response to the cross-reference system 400. With further reference to FIG. 3, the third product cross-reference graphical user interface (GUI) 254 is merely exemplary of a possible layout, possible features, and/or the like. The disclosure contemplates that the third product cross-reference graphical user interface (GUI) 254 may be implemented numerous other ways.

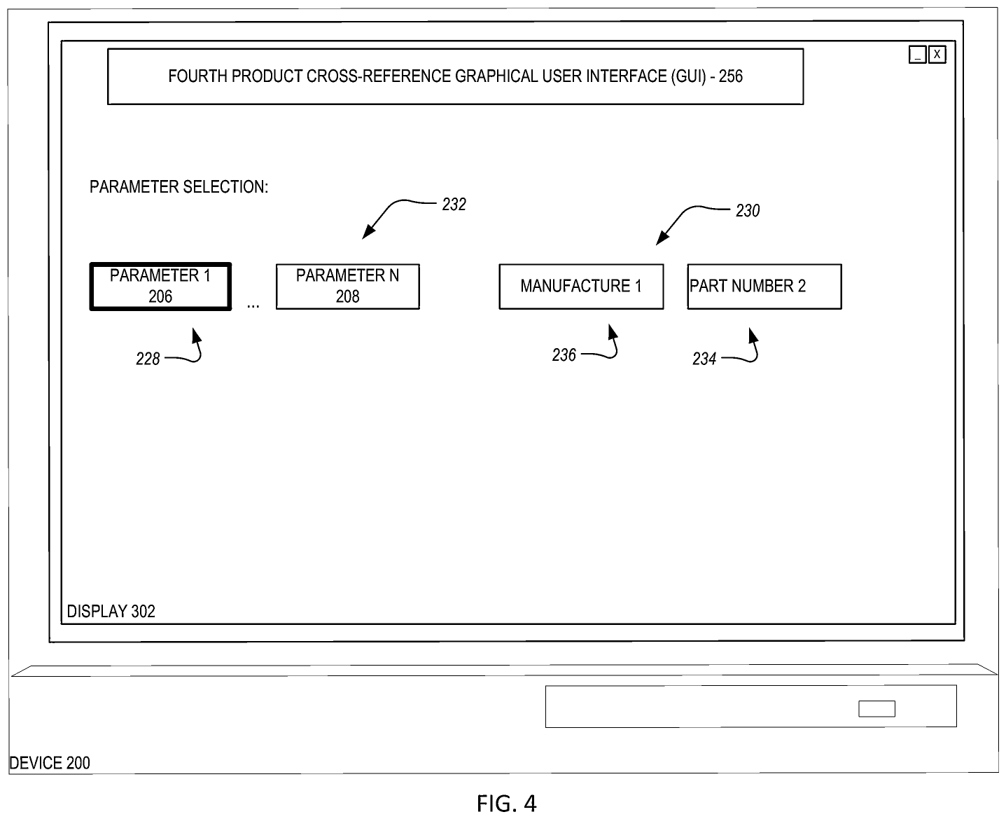

FIG. 4 illustrates a fourth display rendering for data input according to the disclosure.

In particular, FIG. 4 illustrates a fourth product cross-reference graphical user interface (GUI) 256 that includes the reference device data input portion 230, the parameter input portion 232, the first parameter input 206, the second parameter input, . . . the Nth parameter input 208, a device type input, and/or the like for display on the display 302 of a device 300. Additionally, the fourth product cross-reference graphical user interface (GUI) 256 may include a selected one of the listing of manufacturers 236 as well as a selected one of the listing of parts 234. In this regard, the selected one of the listing of parts 234 when implemented consistent with the disclosure may list an actual part number or other part identifier.

Moreover, the fourth product cross-reference graphical user interface (GUI) 256 illustrates a selected one of the parameters 228. In further aspects, the fourth product cross-reference graphical user interface (GUI) 256 may allow a selection of a plurality of the selected one of the parameters 228. Additionally, the fourth product cross-reference graphical user interface (GUI) 256 may allow a priority of a selection of a plurality of the selected one of the parameters 228. Furthermore, the fourth product cross-reference graphical user interface (GUI) 256 may allow a weighting of a selection of each of a plurality of the selected one of the parameters 228.

In this regard, the selected one of the parameters 228 may include one or more parameters, one or more features, one or more characterizations, and/or the like that may be utilized to beneficially and more accurately determine related devices. For example, the selected one of the parameters 228 may include one or more parameters for electrical components such as a qualification, drain-source on-state resistance, a drain-source voltage, a maximum drain current, a polarity, a minimum operating temperature, a maximum operating temperature, a drain-source voltage at one or more particular temperatures, a drain-source voltage, a drain-source voltage at one or more particular temperatures, a pulsed drain current, a DC body diode forward current, a pulsed body diode current, gate-source voltage, max transient voltage, max transient voltage, recommended turn-off gate voltage, short-circuit withstand time, power dissipation, virtual junction temperature, storage temperature, soldering temperature, body diode thermal resistance, junction—case, thermal resistance, junction—ambient, body diode forward voltage, gate-source threshold voltage, zero gate voltage drain current, gate-source leakage current, transconductance, internal gate resistance, input capacitance, output capacitance, reverse capacitance, stored energy, total gate charge, gate to source charge, gate to drain charge, turn-on delay time, rise time, turn-off delay time, fall time, turn-on energy, turn-off energy, total switching energy, diode reverse recovery charge, diode peak reverse recovery current, physical quantities such as device resistances (e.g., gate resistance), device capacitances, device resonant points, inductance, transfer data, such as a device transfer curve, a transfer function, data representative of an independent scalar input versus a dependent scalar output, parametric data, data characterizing both static and dynamic losses, a device transfer curve, a transfer function, data representative of an independent scalar input versus a dependent scalar output, time domain waveforms, parametric data, data characterizing both static and dynamic losses, a gate-source voltage, a device transfer curve, a transfer function, data representative of an independent scalar input versus a dependent scalar output, time domain waveforms, parametric data, data characterizing both static and dynamic losses, of the drain-source current, and/or the like for the device. Other parameters are contemplated as well that may be used to characterize a reference device in order to determine a cross-reference product, a related product, and/or the like.

The fourth product cross-reference graphical user interface (GUI) 256 may be generated by the device 300 and/or the fourth product cross-reference graphical user interface (GUI) 256 may be generated by the device 300 in response to the cross-reference system 400. With further reference to FIG. 4, the fourth product cross-reference graphical user interface (GUI) 256 is merely exemplary of a possible layout, possible features, and/or the like. The disclosure contemplates that the fourth product cross-reference graphical user interface (GUI) 256 may be implemented numerous other ways.

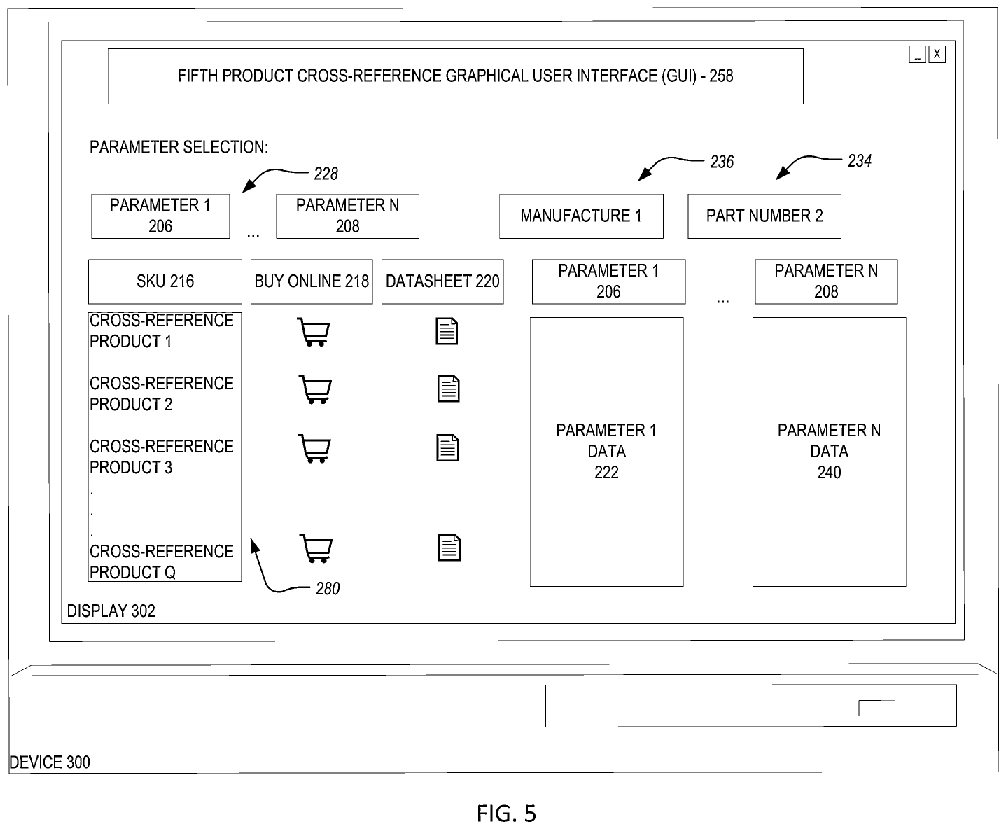

FIG. 5 illustrates a fifth display rendering for data output according to the disclosure.

In particular, FIG. 5 illustrates a fifth product cross-reference graphical user interface (GUI) 258 that may include the selected one of the parameters 228, the selected one of the listing of manufacturers 236, the selected one of the listing of parts 234, a selected one of a device type (not shown), and/or the like. Additionally, the fifth product cross-reference graphical user interface (GUI) 258 may include a listing of cross-reference products 280. In this regard, the listing of cross-reference products 280 may be related products, similar products, commensurate products, functionally equivalent products, a related product, a related device, related devices, a cross-reference product, cross reference products, and/or the like. In particular, as described in greater detail herein, the listing of cross-reference products 280 may be those products that are related to the selected one of the parameters 228, the selected one of the listing of manufacturers 236, the selected one of the listing of parts 234, a selected one of a device type, and/or the like.

In one aspect, the listing of cross-reference products 280 may be those products that match, relate, correlate, approximate, are equal, are equivalent, are approximating, are analogous, are comparable, are complementary, are correlated, are corresponding, are related, are coordinated, are alike, are identical, and/or the like a reference product based on the selected one of the parameters 228, the selected one of the listing of manufacturers 224, the selected one of the listing of parts 234, a selected device type, and/or the like. In one aspect, the listing of cross-reference products 280 may be those products that substantially, that with in a threshold amount, within a threshold percentage, and/or the like match, relate, correlate, approximate, are equal, are equivalent, are approximating, are analogous, are comparable, are complementary, are correlated, are corresponding, are related, are coordinated, are alike, are identical, and/or the like to a reference product based on the selected one of the parameters 228, the selected one of the listing of manufacturers 224, the selected one of the listing of parts 234, a selected device type, and/or the like.

In one aspect, the listing of cross-reference products 280 may be those products that match a reference product by having values of the selected one of the parameters 228, the selected one of the listing of manufacturers 224, the selected one of the listing of parts 234, a selected device type, and/or the like that may be the closest to the reference product. In one aspect, the listing of cross-reference products 280 may be those products that match a reference product by having values of the selected one of the parameters 228, the selected one of the listing of manufacturers 224, the selected one of the listing of parts 234, a selected device type, and/or the like that may be the closest to the reference product as well as the next closest to the reference product, a second next closest to the reference product, and/or an nth next closest to the reference product.

In this regard, a match of a cross-reference product may be a product having a value of the selected one of the parameters 228 that is closest, that is within a threshold amount of a value of the selected one of the parameters 228, that is within threshold percentage of a value of the selected one of the parameters 228, and/or the like. Additionally, the disclosed process, system, and device may find the next closest product match with a parameter less than or greater than the desired value. Furthermore, the disclosed process, system, and device may find the next closest product match with a parameter less than the desired value and the next closest product match with a parameter greater than the desired value. Additionally, the disclosed process, system, and device may find the next closest products having a match with a parameter less than the desired value and/or the next closest products having a match with a parameter greater than the desired value. Moreover, the disclosed process, system, and device may find the next closest product, the next adjacent product, the next neighbor product, and/or the like having a parameter less than the desired value and/or greater than the desired value. Additionally, the disclosed process, system, and device may find the next closest products having a match with a parameter less than the desired value and/or the next closest products having a match with a parameter greater than the desired value.

Moreover, a match of a cross-reference product may be a product having values of a plurality of the selected one of the parameters 228 that are closest, that are within a threshold amount of a values of a plurality of the selected one of the parameters 228, that are within threshold percentage values of a plurality of the selected one of the parameters 228, and/or the like. Additionally, the disclosed process, system, and device may find the next closest product match with one or more parameters less than or greater than the desired value. Moreover, the disclosed process, system, and device may find the next closest product match with one or more parameters less than the desired value and the next closest product match with one or more parameters greater than the desired value. Furthermore, the disclosed process, system, and device may find the next closest products that have a match with one or more parameters less than the desired value and/or the next closest products that have a match with one or more parameters greater than the desired value. Additionally, a match of a cross-reference product may be a product that is the same type of device, the closest type of device, a related type of device, and/or the like as the device that is the selected one of the listing of parts 234.

Additionally, the fifth product cross-reference graphical user interface (GUI) 258 may include a stock-keeping unit (SKU) 216 for each of the cross-reference products, a buy online icon 218 for the each of cross-reference products, a datasheet icon 220 for each of the cross-reference products, a first parameter data listing 222 for each of the cross-reference products, an Nth parameter data listing 240 for each of the cross-reference products, and/or the like. The buy online icon 218 may be configured to be actuated and generate a separate graphical user interface providing ordering functions, payment functions, delivery functions, and/or the like. The datasheet icon 220 may be configured to be actuated and generate a separate graphical user interface providing datasheet information and/or the like.

The fifth product cross-reference graphical user interface (GUI) 258 may be generated by the device 300 and/or the fifth product cross-reference graphical user interface (GUI) 258 may be generated by the device 300 in response to the cross-reference system 400. With further reference to FIG. 5, the fifth product cross-reference graphical user interface (GUI) 258 is merely exemplary of a possible layout, possible features, and/or the like. The disclosure contemplates that the fifth product cross-reference graphical user interface (GUI) 258 may be implemented numerous other ways.

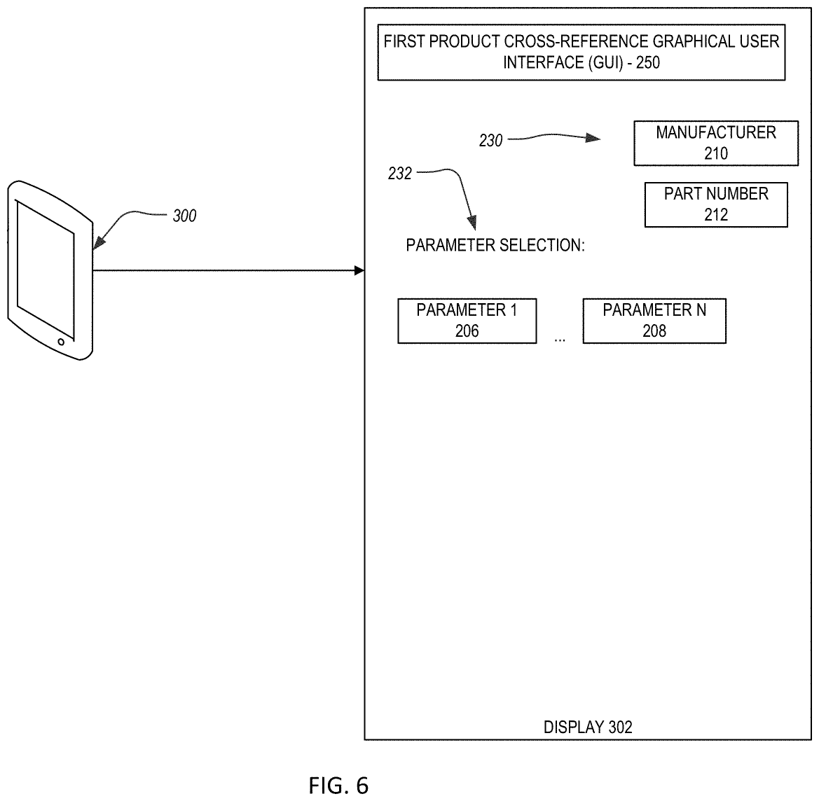

FIG. 6 illustrates another first display rendering for data input according to the disclosure.

In particular, FIG. 6 illustrates the first product cross-reference graphical user interface (GUI) 250 that may include the reference device data input portion 230 for display on the display 302 of the device 300. The first product cross-reference graphical user interface (GUI) 250 may additionally or alternatively include the parameter input portion 232 for display on the display 302 of the device 300. In this regard, FIG. 6 illustrates the first product cross-reference graphical user interface (GUI) 250 implemented in the device 300 with a different ratio sized implementation of the display 302 such as for a personal digital assistant (PDA), a tablet computer, a smartphone, and/or the like.

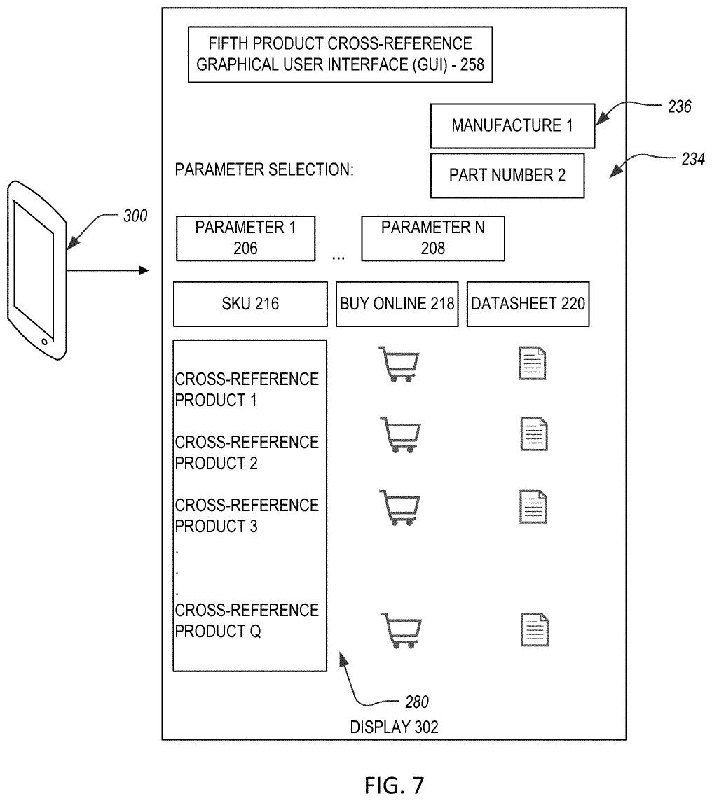

FIG. 7 illustrates another fifth display rendering for data output according to the disclosure.

In particular, FIG. 7 illustrates the fifth product cross-reference graphical user interface (GUI) 258 that may include the selected one of the parameters 228, the selected one of the listing of manufacturers 236, the selected one of the listing of parts 234, the listing of cross-reference products 280, the stock-keeping unit (SKU) 216 for each of the cross-reference products, the buy online icon 218 for the each of cross-reference products, the datasheet icon 220 for each of the cross-reference products, and/or the like. In this regard, FIG. 7 illustrates the fifth product cross-reference graphical user interface (GUI) 258 implemented in the device 300 with a different ratio sized implementation of the display 302 such as for a personal digital assistant (PDA), a tablet computer, a smartphone, and/or the like. Likewise, the various other cross-reference graphical user interfaces (GUIs) of the disclosure may likewise be implemented in the device 300 with a different ratio sized implementation of the display 302 such as for a personal digital assistant (PDA), a tablet computer, a smartphone, and/or the like.

The first product cross-reference graphical user interface (GUI) 250, the second product cross-reference graphical user interface (GUI) 252, the third product cross-reference graphical user interface (GUI) 254, the fourth product cross-reference graphical user interface (GUI) 256, the fifth product cross-reference graphical user interface (GUI) 258, and/or the like may be generated by the device 300 and/or may be generated by the device 300 in response to a cross-reference system 400. In further aspects, the first product cross-reference graphical user interface (GUI) 250, the second product cross-reference graphical user interface (GUI) 252, the third product cross-reference graphical user interface (GUI) 254, the fourth product cross-reference graphical user interface (GUI) 256, the fifth product cross-reference graphical user interface (GUI) 258, and/or the like may be generated by the device 300 and/or may be generated by the device 300 in response to a cross-reference system 400 as part of implementation of an application, implementation of a browser, implementation of a web-based tool, and/or the like. Additionally, the features of the various graphical user interfaces may be implemented in additional graphical user interfaces, may be implemented in fewer graphical user interfaces, may be combined, may include additional features, and/or the like.

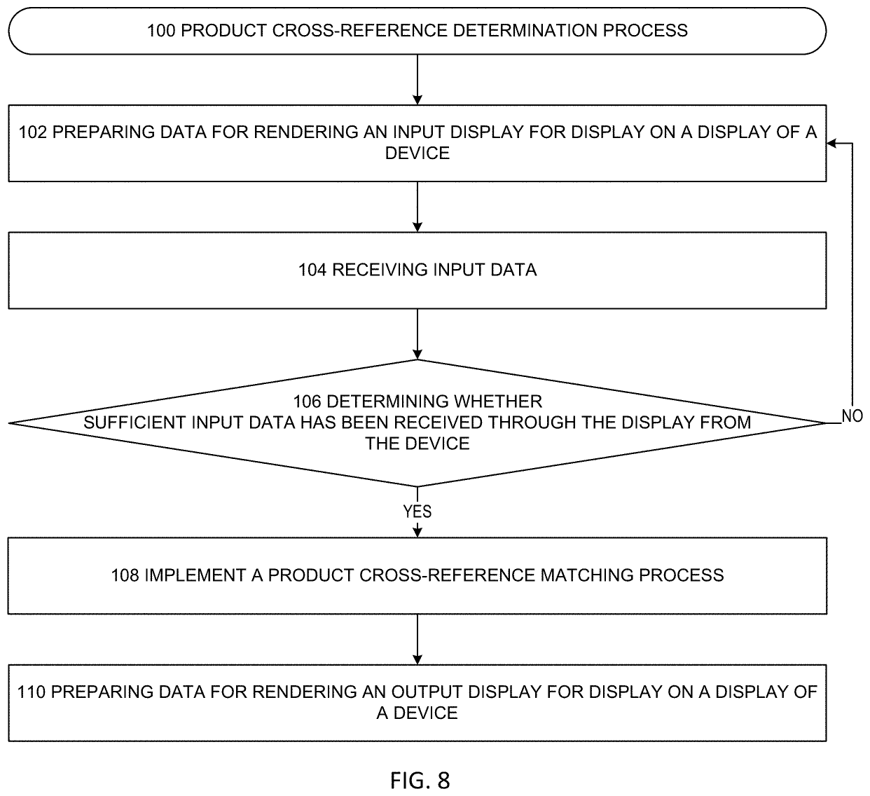

FIG. 8 illustrates a process according to the disclosure.

In particular, FIG. 8 illustrates a product cross-reference determination process 100. It should be noted that the aspects of the product cross-reference determination process 100 may be performed in a different order consistent with the aspects described herein. Moreover, the product cross-reference determination process 100 may be modified to have more or fewer processes consistent with the various aspects disclosed herein.

The product cross-reference determination process 100 may be implemented by the device 300, the product cross-reference determination process 100 may be implemented by the device 300 in response to a cross-reference system 400, and/or the like. In one aspect, the product cross-reference determination process 100 may be implemented with an application 360 by the device 300. In one aspect, the product cross-reference determination process 100 may be implemented by a web browser implemented by the device 300 in response to the cross-reference system 400. In one aspect, the product cross-reference determination process 100 may be implemented as a web-based tool.

The product cross-reference determination process 100 may include preparing data for rendering a reference input display for display on a display of a device 102. In particular, the preparing data for rendering a reference input display for display on the display 302 of the device 300 may include preparing data for rendering a reference input display for one or more of the reference device data input portion 230, the parameter input portion 232, the first parameter input 206, the Nth parameter input 208, the manufacturer input 210, the part number input 212, the device type input, and/or the like as described herein.

In one aspect, the preparing data for rendering a reference input display for display on a display of a device 102 may include generating data for one or more graphical user interfaces on the display 302 of the device 300. In one aspect, the preparing data for rendering a reference input display for display on a display of a device 102 may include generating the reference device data input portion 230, the parameter input portion 232, the selected one of the listing of manufacturers 224, the listing of parts 226, the selected one of the listing of manufacturers 236, the selected one of the listing of parts 234, the device type input, and/or the like on the display 302 of the device 300. In one aspect, the preparing data for rendering a reference input display for display on a display of a device 102 may include generating the first product cross-reference graphical user interface (GUI) 250, the second product cross-reference graphical user interface (GUI) 252, the third product cross-reference graphical user interface (GUI) 254, the fourth product cross-reference graphical user interface (GUI) 256, and/or the like on the display 302 of the device 300.

The product cross-reference determination process 100 may include receiving input data 104. In particular, the product cross-reference determination process 100 may include the receiving input data 104 through the display 302 of the device 300. In one aspect, the receiving input data 104 may include receiving input data through the reference device data input portion 230, the parameter input portion 232, the manufacturer input 210, the listing of parts 226, the selected one of the listing of manufacturers 236, the selected one of the listing of parts 234, and/or the like on the display 302 of the device 300. In one aspect, the receiving input data 104 may include receiving input data through the first product cross-reference graphical user interface (GUI) 250, the second product cross-reference graphical user interface (GUI) 252, the third product cross-reference graphical user interface (GUI) 254, the fourth product cross-reference graphical user interface (GUI) 256, and/or the like on the display 302 of the device 300. Additionally, the receiving input data 104 may include receiving the input data into the device 300, transmitting the input data over a network utilizing a communication channel as defined herein to another system, such as the cross-reference system 400, and/or the like.

The product cross-reference determination process 100 may include determining whether sufficient input data has been received through the display from the device 106. In this regard, the product cross-reference determination process 100 may repeat the process of preparing data rendering an input display for display on a display of a device 300 and receiving input data 104.

If the product cross-reference determination process 100 determines sufficient input data has been received, the product cross-reference determination process 100 advances to a product cross-reference matching process 108. On the other hand, if the product cross-reference determination process 100 determines insufficient input data has been set received, the product cross-reference determination process 100 may provide an indication that additional data is needed and continue the preparing data rendering an input display for display on a display of a device 300 and receiving input data through the display 302 of the device 300.

After the product cross-reference determination process 100 determines sufficient input data has been received, the product cross-reference determination process 100 may implement the product cross-reference matching process 108. In particular, the product cross-reference matching process 108 may determine at least one product that matches a manufacturer name, a part number, a parameter selection, multiple manufacturer names, multiple part numbers, multiple parameter selections, and/or the like received from the device 300. In particular, the product cross-reference matching process 108 may determine a plurality of products that match a manufacturer name, a part number, a parameter selection, multiple manufacturer names, multiple part numbers, multiple parameter selections, a device type, types of devices, and/or the like received from the device 300.

In particular aspects, the product cross-reference matching process 108 may utilize matching criteria based on a manufacturer name, a part number, a parameter selection, multiple manufacturer names, multiple part numbers, multiple parameter selections, and/or the like received from the device 300. In this regard, the matching criteria may be utilized to generate the listing of cross-reference products 280 that may be related products, similar products, commensurate products, functionally equivalent products, and/or the like. In particular, the matching criteria may be based on the one of the parameters 228, the selected one of the listing of manufacturers 236, the selected one of the listing of parts 234, a selected one of a device type, and/or the like. More specifically, the product cross-reference matching process 108 may utilize the matching criteria as search criteria for searching a storage 408 of the cross-reference system 400 and/or searching a memory 316 of the device 300 for determining the listing of cross-reference products 280 that may be those products that match, relate, correlate, approximate, and/or the like a reference product based on the selected one of the parameters 228, the selected one of the listing of manufacturers 224, the selected one of the listing of parts 234, a selected device type, and/or the like.

In this regard, a match or matching of a cross-reference product may be a product having a value of the selected one of the parameters 228 that is closest, that is within a threshold amount of a value of the selected one of the parameters 228, that is within threshold percentage of a value of the selected one of the parameters 228, and/or the like. Additionally, the disclosed process, system, and device may find the next closest product match with a parameter less than or greater than the desired value. Furthermore, the disclosed process, system, and device may find the next closest product match with a parameter less than the desired value and the next closest product match with a parameter greater than the desired value. Additionally, the disclosed process, system, and device may find the next closest products having a match with a parameter less than the desired value and/or the next closest products having a match with a parameter greater than the desired value.

Moreover, a match of a cross-reference product may be a product having values of a plurality of the selected one of the parameters 228 that are closest, that are within a threshold amount of a values of a plurality of the selected one of the parameters 228, that are within threshold percentage values of a plurality of the selected one of the parameters 228, and/or the like. Additionally, the disclosed process, system, and device may find the next closest product match with one or more parameters less than or greater than the desired value. Moreover, the disclosed process, system, and device may find the next closest product match with one or more parameters less than the desired value and the next closest product match with one or more parameters greater than the desired value. Furthermore, the disclosed process, system, and device may find the next closest products that have a match with one or more parameters less than the desired value and the next closest products that have a match with one or more parameters greater than the desired value. Additionally, a match of a cross-reference product may be a product that is the same type of device, the closest type of device, a related type of device, and/or the like as the device that is the selected one of the listing of parts 234.

The product cross-reference determination process 100 may alternatively and/or further utilize artificial intelligence and/or machine learning to match a manufacturer name, a part number, a parameter selection, multiple manufacturer names, multiple part numbers, multiple parameter selections, and/or the like received from the device 300 to determine the listing of cross-reference products 280. The artificial intelligence and/or machine learning may utilize any number of approaches including one or more of cybernetics and brain simulation, symbolic, cognitive simulation, logic-based, anti-logic, knowledge-based, sub-symbolic, embodied intelligence, computational intelligence and soft computing, machine learning and statistics, and the like.

A further aspect of the disclosure is a process, system, and device that has the ability to update product data dynamically by capturing data directly from manufacturers' parametric tables, graphics, text, and/or the like on their own websites (hereinafter generally referred to as parametric tables for ease of description), and using an algorithm to automatically choose the right devices to recommend. Every time a manufacturer releases a new product, makes any changes to an existing product, and/or the like, the disclosed cross-reference process, system, and device may collect the most up-to-date product data information and accordingly may choose the right comparable products with the most up-to-date information.

In particular, the device 300 and/or the cross-reference system 400 may be configured to periodically update product data dynamically. More specifically, the device 300 and/or the cross-reference system 400 may capture data directly from manufacturers' parametric tables on their own websites. Thereafter, the device 300 and/or the cross-reference system 400 may analyze parametric tables and modify the data associated with the parametric tables to provide data to utilize the matching criteria as described herein. The modification of the data associated with the parametric tables to provide data to utilize the matching criteria may utilize an algorithm. Thereafter, the storage 408 and/or the memory 316 may be updated with the modified data so that the matching process of the product cross-reference matching process 108 may automatically choose the right devices to recommend. The modification of the data associated with the parametric tables may be homogenized, normalized, equalized, and/or the like to ensure accurate comparisons and matching.

The modification of the data associated with the parametric tables to provide data to utilize the matching criteria may alternatively and/or further utilize artificial intelligence and/or machine learning. The artificial intelligence and/or machine learning may utilize any number of approaches including one or more of cybernetics and brain simulation, symbolic, cognitive simulation, logic-based, anti-logic, knowledge-based, sub-symbolic, embodied intelligence, computational intelligence and soft computing, machine learning and statistics, and the like.

The product cross-reference determination process 100 may include outputting a listing of cross-reference products 110. In one aspect, the outputting a listing of cross-reference products 110 may include preparing data for rendering an output display for display on the display 302 of the device 300. In particular, the outputting a listing of cross-reference products 110 may include generating data for display of the fifth product cross-reference graphical user interface (GUI) 258. In one aspect, the outputting a listing of cross-reference products 110 may include generating data for display on the display 302 of the device 300 that includes the listing of cross-reference products 280, the stock-keeping unit (SKU) 216, the buy online icon 218, the datasheet icon 220, the first parameter data listing 222, the Nth parameter data listing 240, and/or the like.

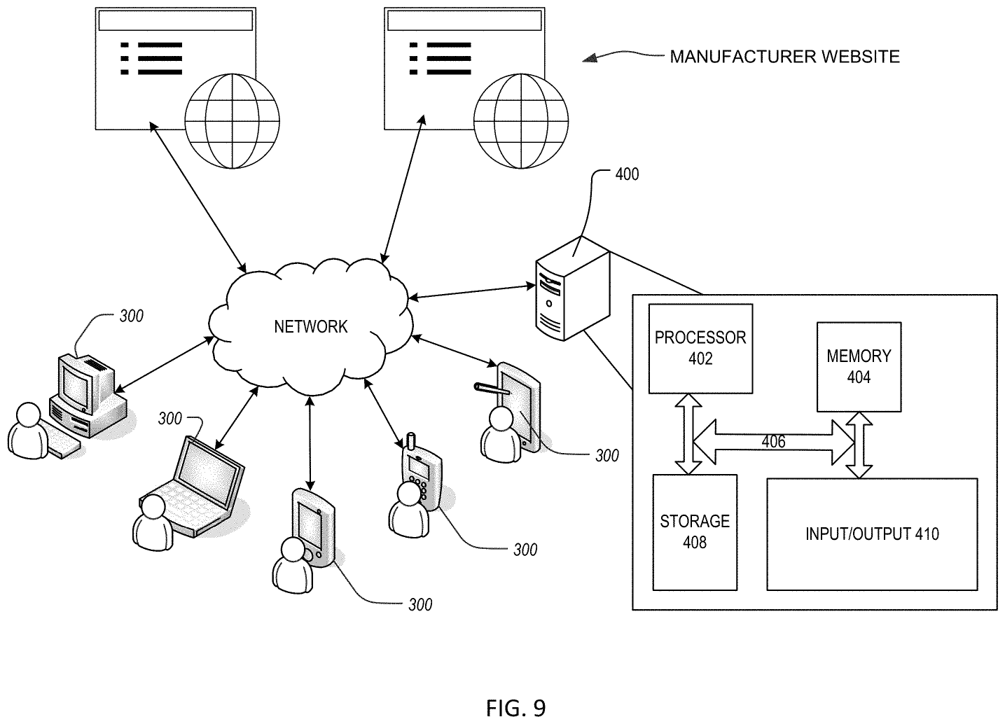

FIG. 9 illustrates a system according to the disclosure.

In particular, FIG. 9 illustrates a cross-reference system 400 in accordance with an aspect of the disclosure as illustrated in FIG. 9. The cross-reference system 400 illustrated in FIG. 9 may be used to provide cross-reference product data to the device 300. The cross-reference system 400 may implement at least in part the product cross-reference determination process 100.

In particular aspects, the cross-reference system 400 may include a processor 402, a memory 404, an input/output 410, a bus 406, and/or the like. In particular aspects, the cross-reference system 400 may include generating data for display on the display 302 of the device 300 that includes the listing of cross-reference products 280, the stock-keeping unit (SKU) 216, the buy online icon 218, the datasheet icon 220, the first parameter data listing 222, the Nth parameter data listing 240, the reference device data input portion 230, the parameter input portion 232, the manufacturer input 210, the listing of parts 226, the selected one of the listing of manufacturers 236, the selected one of the listing of parts 234, and/or the like. In one aspect, the cross-reference system 400 may include receiving input data through the first product cross-reference graphical user interface (GUI) 250, the second product cross-reference graphical user interface (GUI) 252, the third product cross-reference graphical user interface (GUI) 254, the fourth product cross-reference graphical user interface (GUI) 256, and/or the like on the display 302 of the device 300.

The cross-reference system 400 may include a storage 408 such as a database that includes data for the listing of cross-reference products 280, the stock-keeping unit (SKU) 216, the buy online icon 218, the datasheet icon 220, the first parameter data listing 222, the Nth parameter data listing 240, the reference device data input portion 230, the parameter input portion 232, the manufacturer input 210, the listing of parts 226, the selected one of the listing of manufacturers 236, the selected one of the listing of parts 234, and/or the like. The storage 408 may further include software for implementing at least in part the product cross-reference determination process 100.

In one aspect, the cross-reference system 400 may be configured to periodically update product data dynamically. More specifically, the cross-reference system 400 may capture data directly from manufacturers' parametric tables on their own websites. In particular, the cross-reference system 400 may connect to a manufacturer website over a network utilizing a communication channel as defined herein as illustrated in FIG. 9. Thereafter, the cross-reference system 400 may capture parameter data, parametric table data, mine parametric table data, mine parameter data, and/or the like from a manufacturer website. In one aspect, the cross-reference system 400 may scrape parameter data, parametric table data, and/or the like from a manufacturer website. Additionally, the cross-reference system 400 may analyze the parameter data, the parametric table data, and/or the like. Moreover, the cross-reference system 400 may modify the data associated with the parameter data, the parametric table data, and/or the like to generate data to utilize the matching criteria as described herein. The modification of the data associated with the parameter data, the parametric table data, and/or the like to provide data to utilize the matching criteria may utilize an algorithm. Thereafter, the cross-reference system 400 may update the storage 408 with the modified data. The one data associated with the parameter data, parametric table data, and/or the like may be homogenized, normalized, equalized, interpreted, analyzed, resolved, and/or the like by the cross-reference system 400 to ensure accurate comparisons, matching, and/or the like.

In one aspect, the cross-reference system 400 may be implemented by a server. In one aspect, the cross-reference system 400 may connect to the device 300 over a network utilizing a communication channel as defined herein. In one aspect, the cross-reference system 400 may be configured to implement a web tool, a website, a web portal, and/or the like.

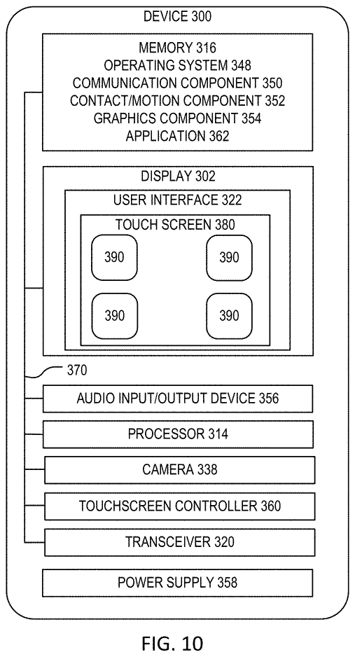

FIG. 10 illustrates a device according to the disclosure.

In particular, FIG. 10 illustrates the device 300 in accordance with an aspect of the disclosure. In one aspect, the disclosed process, system, and device may be implemented in conjunction with the device 300 and may be responsive to the cross-reference system 400 executing the product cross-reference determination process 100. In one aspect, the disclosed process, system, and device may be implemented in conjunction with the device 300 executing the application 360. In one aspect, the disclosed process, system, and device may be implemented in conjunction with the device 300 executing the product cross-reference determination process 100. In one aspect, the disclosed process, system, and device may be implemented in conjunction with the device 300 that may be responsive to the cross-reference system 400 partially executing the product cross-reference determination process 100 and the device 300 partially executing the product cross-reference determination process 100 and/or the application 360.

The device 300 may be an internet enabled device that may be implemented as a personal computer (PC), a laptop, a personal digital assistant (PDA), a tablet computer, a workstation, and/or the like. In one aspect, the device 300 may be implemented as a smartphone implementing any type of advanced mobile data processing and communication operating system, such as, e.g., an Apple™ iOS™ operating system, a Google™ Android™ operating system, a RIM™ Blackberry™ operating system, a Nokia™ Symbian™ operating system, a Microsoft™ Windows Mobile™ operating system, a Microsoft™ Windows Phone™ operating system, a Linux™ operating system or the like.

The product cross-reference determination process 100 and/or the application 360 described in the disclosure may be implemented to execute on an Apple™ iOS™ operating system, a Google™ Android™ operating system, a RIM™ Blackberry™ operating system, a Nokia™ Symbian™ operating system, a Microsoft™ Windows Mobile™ operating system, a Microsoft™ Windows Phone™ operating system, a Linux™ operating system or the like. The product cross-reference determination process 100 and/or the application 360 may be displayed as an icon. The product cross-reference determination process 100 and/or the application 360 may have been downloaded from the Internet, pre-installed, or the like. In some aspects, the product cross-reference determination process 100 and/or the application 360 may be obtained from Google Play™, Android Market™, Apple Store™, or the like digital distribution source. The product cross-reference determination process 100 may be written in conjunction with the software developers kit (SDK) associated with an Apple™ iOS™ operating system, a Google™ Android™ operating system, a RIM™ Blackberry™ operating system, a Nokia™ Symbian™ operating system, a Microsoft™ Windows Mobile™ operating system, a Microsoft™ Windows Phone™ operating system, a Linux™ operating system or the like.

In one aspect, the device 300 may be in Internet enabled device implementing a browser that provides at least partially the functionality consistent with the product cross-reference determination process 100 implemented by the cross-reference system 400. In one aspect, the device 300 may implement a web-based tool that provides the functionality consistent with the product cross-reference determination process 100 implemented by the cross-reference system 400. In one aspect, the device 300 may implement an application 360 that provides the functionality consistent with the product cross-reference determination process 100 implemented by the cross-reference system 400.

The device 300 may include a memory 316. The memory 316 may store the application 360, an application implementing at least in part the product cross-reference determination process 100, and the memory 316 may store data for the listing of cross-reference products 280, the stock-keeping unit (SKU) 216, the buy online icon 218, the datasheet icon 220, the first parameter data listing 222, the Nth parameter data listing 240, the reference device data input portion 230, the parameter input portion 232, the manufacturer input 210, the listing of parts 226, the selected one of the listing of manufacturers 236, the selected one of the listing of parts 234, and/or the like. The device 300 may further include an operating system 348, a communication component 350, a contact/motion component 352, a graphics component 354, and/or the like. The operating system 348 together with the various components provides software functionality for each of the components of the device 300. The memory 316 may include a high-speed, random-access memory. Also, the memory 316 may be a non-volatile memory, such as magnetic fixed disk storage, flash memory, and/or the like. These various components may be connected through various communication lines including a data bus 370.

The device 300 may also include a processor 314 which may be a central processing unit configured to execute instructions, such as, for example, instructions related to software programs. Any processor can be used for the device 300 as understood by those of ordinary skill in the art. The processor 314 may be coupled to the graphical user interface (GUI) 322 and the memory 316. The display 302 may be a liquid crystal display (LCD). Preferably the LCD includes a backlight to illuminate the various color liquid crystals to provide a more colorful display. The graphical user interface (GUI) 322 may be any type of physical input as readily employed in the field. For example, the user interface may have physical buttons. Alternatively, the user interface may be implemented on a touchscreen. Additionally, the device 300 includes a power supply 358. The application 360, an application implementing the product cross-reference determination process 100, and/or the like may be executed by the processor 314.

The device 300 may include an audio input/output device 356. The audio input/output device 356 may include speakers, speaker outputs, microphones, microphone inputs, and the like, for receiving and sending sound inputs. In an exemplary aspect, the audio input/output device 356 may include an analog to digital converter and a digital to audio converter for audio input and output functions respectively. In one aspect, the audio input/output device 356 may be configured to receive via voice recognition input for the reference device data input portion 230, the part number input 212, the manufacturer input 210, the selected one of the listing of manufacturers 236, the selected one of the listing of parts 234, the selected one of the parameters 228, the device type, the parameter input portion 232, and/or the like.

The device 300 may include a camera 338 that is multifunctional. The camera 338 may be used to capture images for the reference device data input portion 230, the part number input 212, the manufacturer input 210, and/or the like, which may include letters, symbols, and numbers (optical character reading/machine code reading), an image of a machine code, which may include a bar code such as a QR code, a Data Matrix (DM) code, a Universal Product Code (UPC), and/or the like. The camera 338 may be on the front, back, sides and/or the like of the device 300.

The camera 338 may include a charge coupled device (CCD), CMOS image sensors, Back Side Illuminated CMOS, and/or the like. Images captured by the camera 338 may be converted and stored in various formats including a JPEG file format, RAW feature format such as the Android (operating system) 5.0 Lollipop, and/or the like. Additionally, the device 300 may include an application for display of images captured by the camera 338.

In a particular aspect, the camera 338 may include functionality as a barcode reader, a Data Matrix code reader, a QR code reader, and/or the like. A QR code (Quick Response Code) is a type of matrix barcode (or two-dimensional barcode). The matrix barcode may be a machine-readable optical label that contains information about the item to which it is attached. A QR code uses a number of standardized encoding modes including numeric, alphanumeric, byte/binary, and the like to efficiently store data. The QR code may include black modules arranged in a square grid on a white background, which can be read by the camera 338 or other imaging device and processed using, for example, Reed-Solomon error correction until the image can be appropriately interpreted. The required data may then be extracted from patterns that are present in both horizontal and vertical components of the image.

In a particular aspect, the camera 338 may include functionality as a Data Matrix code reader. A Data Matrix code is a two-dimensional matrix barcode (machine-readable) including black and white “cells” or modules arranged in either a square or rectangular pattern. The Data Matrix code may be implemented with the ECC 200 version of Data Matrix and include Reed-Solomon codes for error and erasure recovery. Other protocols and/or versions of the Data Matrix are contemplated as well.

In a particular aspect, the camera 338 may include functionality as a Universal Product Code (UPC) reader. The UPC is a barcode symbology utilizing protocols such as UPC-A, UPC-E, European Article Number (EAN), UPC-B, UPC-C UPC-D, UPC-2, UPC-5, and/or the like type machine-readable codes.

The camera 338 may be in communication with the processor 314, the memory 316, and the graphical user interface (GUI) 322. Moreover, the camera 338 may be in direct communication with an analog to digital converter. Accordingly, the camera 338 may capture the machine-readable code, such as the bar code, the QR code, the Data Matrix, and/or the like and generate an analog signal. The analog signal may be converted to a digital signal for processing by the processor 314. The processor 314 may be a central processing unit configured to execute instructions such as instructions related to software programs. Any processor such as a microprocessor, Field-Programmable Gate Array (FPGA), an Application Specific Integrated Circuits (ASIC), a controller, a chipset, a System-on-a-Chip (SoC), a Central Processing Unit (CPU), a Graphics Processing Unit (GPU), an Image Processing Unit (ISP), a Digital Signal Processor (DSP), a Neural Processing Unit (NPU), a Video encoder/decoder, a Modem, and/or the like can be used in the device 300 as understood to those of ordinary skill in the art.

Additionally, the camera 338 may capture an image of the device and/or the like and generate an analog signal. The analog signal may be converted to a digital signal for processing by the processor 314 as the input data. Thereafter, the device 300 and/or the cross-reference system 400 may compare the image-based input data to stored images to determine a part number, a manufacturer, a device type, and/or the like. In particular, the device 300 and/or the cross-reference system 400 may compare an outline of a reference device, features of a reference device, arrangement of a reference device, a configuration of a reference device, and/or the like of the image based input data to stored images to determine a part number, a manufacturer, a device type, and/or the like.

In a further aspect, the device 300 may include a transceiver 320. The device 300 may provide radio and signal processing as needed to access a network for services in conjunction with the transceiver 320. The processor 314 may be configured to process functions, data transfer, and the like and provide other services to the user.

In an exemplary aspect, the touchscreen of the disclosure may be implemented in the display 302 and may detect a presence and location of a touch of a user within the display area. For example, touching the display 302 of the device 300 with a finger or hand. The touchscreen may also sense other passive objects, such as a stylus. The device 300 may further include a touch screen controller 362.

In operation, the display 302 may show objects 390 associated with applications for execution by the processor 314. For example, a user may touch the display 302, particularly the touchscreen, to interact with the objects 390. That is, touching an object 390 may execute an application in the processor 314 associated with the object 390 that is stored in memory 316. In particular, the object 390 may be the application 360 associated with the product cross-reference determination process 100. Additionally or alternatively, touching an object 390 may open a menu of options to be selected by the user. The display 302 may include a plurality of objects 390 for the user to interact with. Moreover, the display 302 may include a plurality of screens. The display 302 showing one screen at a time. The user may interact with the display 302 to move a screen into view on the display 302. Various ones of the objects 390 may be located in each of the screens.

The touchscreen may have different implementations. The touchscreen may be implemented as a resistive touchscreen, a surface acoustic wave touch screen, a capacitive touch screen, a surface capacitance touchscreen, projected capacitive touch screen, self-capacitance sensors, infrared sensors, dispersive signal technology, acoustic pulse recognition, or the like.

The display 302 may be generally configured to display a graphical user interface (GUI) 322 that provides an easy to use visual interface between a user of the device 300 and the operating system, an application implementing the product cross-reference determination process 100, the application 360, other application(s) running on the device 300. Generally, the graphical user interface (GUI) 322 may present programs, files and operational options with graphical images. During operation, the user may select and activate various graphical images which appear on the display 302 in order to initiate functions and tasks associated therewith. In one aspect, the graphical user interface (GUI) 322 may generate the first product cross-reference graphical user interface (GUI) 250, the second product cross-reference graphical user interface (GUI) 252, the third product cross-reference graphical user interface (GUI) 254, the fourth product cross-reference graphical user interface (GUI) 256, the fifth product cross-reference graphical user interface (GUI) 258, and/or the like.

In one or more aspects, the device 300, the cross-reference system 400, and/or the like implementing the product cross-reference determination process 100 may be configured with the storage 408 and/or the memory 316 to utilize a manually-updated lookup table as the data source, a 3rd-party aggregator database as the data source, and/or other type of data source.

In one or more aspects, the device 300, the cross-reference system 400, and/or the like implementing the product cross-reference determination process 100 may be configured as a mobile device, a desktop device, and/or the like. In one or more aspects, the device 300, the cross-reference system 400, and/or the like implementing the product cross-reference determination process 100 may include off-line implementations that may sync to a central source that drives the web-based tool.

In one or more aspects, the device 300, the cross-reference system 400, and/or the like implementing the product cross-reference determination process 100 may be implemented as a standalone webpage or other webpage that does not include a complete parametric table

In one or more aspects, the device 300, the cross-reference system 400, and/or the like implementing the product cross-reference determination process 100 may be configured to operate in reverse. In particular, the device 300, the cross-reference system 400, and/or the like implementing the product cross-reference determination process 100 may be configured to receive selection of a part number and may provide competitors' closest matches.

In one or more aspects, the device 300, the cross-reference system 400, and/or the like implementing the product cross-reference determination process 100 may be configured to operate to use multiple parameters.

The disclosure has set forth implementations of a process, system and/or device for more accurately determining products from multiple suppliers substantially matching various desired parameters. Additionally, the disclosure has set forth implementations of a process, system and/or device for more quickly determining products from the multiple suppliers substantially matching various desired parameters.

For the purposes of this disclosure a computer readable medium stores computer data, which data can include computer program code that is executable by a processor in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and nonremovable storage media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage media, magnetic cassettes, magnetic tape, magnetic disk storage or other magnetic storage devices, or any other physical or material medium which can be used to tangibly store the desired information or data or instructions and which can be accessed by a processor or computing device. In one or more aspects, the actions and/or events of a method, algorithm, or module may reside as one or any combination or set of codes and/or instructions on a computer readable medium or machine readable medium, which may be incorporated into a computer program product.

The disclosed system, process, and/or device, which may include the device 300, the cross-reference system 400, and/or the like may be configured to utilize communication channels that may be any type of wired or wireless electronic communications network, such as, e.g., a wired/wireless local area network (LAN), a wired/wireless personal area network (PAN), a wired/wireless home area network (HAN), a wired/wireless wide area network (WAN), a campus network, a metropolitan network, an enterprise private network, a virtual private network (VPN), an internetwork, a backbone network (BBN), a global area network (GAN), the Internet, an intranet, an extranet, an overlay network, a cellular telephone network, a Personal Communications Service (PCS), using known protocols such as the Global System for Mobile Communications (GSM), CDMA (Code-Division Multiple Access), Long Term Evolution (LTE), 5G (fifth generation), W-CDMA (Wideband Code-Division Multiple Access), Wireless Fidelity (Wi-Fi), Bluetooth, Near field communication (NFC), and/or the like, and/or a combination of two or more thereof. The NFC standards cover communications protocols and data exchange formats, and are based on existing radio-frequency identification (RFID) standards including ISO/IEC 14443 and FeliCa. The standards include ISO/IEC 18092[3] and those defined by the NFC Forum.

Aspects of the disclosure may include a server executing an instance of an application or software configured to accept requests from a client and giving responses accordingly. The server may run on any computer including dedicated computers. The computer may include at least one processing element, typically a central processing unit (CPU), and some form of memory. The processing element may carry out arithmetic and logic operations, and a sequencing and control unit may change the order of operations in response to stored information. The server may include peripheral devices that may allow information to be retrieved from an external source, and the result of operations saved and retrieved. The server may operate within a client-server architecture. The server may perform some tasks on behalf of clients. The clients may connect to the server through the network on a communication channel as defined herein. The server may use memory with error detection and correction, redundant disks, redundant power supplies and so on.

Aspects of the disclosure may be web-based. For example, a server may operate a web application in conjunction with a database. The web application may be hosted in a browser-controlled environment (e.g., a Java applet and/or the like), coded in a browser-supported language (e.g., JavaScript combined with a browser-rendered markup language (e.g., Hyper Text Markup Language (HTML) and/or the like)) and/or the like such that any computer running a common web browser (e.g., Internet Explorer™, Firefox™, Chrome™, Safari™ or the like) may render the application executable. A web-based service may be beneficial due to the ubiquity of web browsers and the convenience of using a web browser as a client (i.e., thin client). Further, with inherent support for cross-platform compatibility, the web application may be maintained and updated without distributing and installing software on each.

The web-based tool may be implemented as a web portal that may be a website that brings information from diverse sources. In some aspects, each information source may generate a dedicated area on the page for displaying information (a portlet). In some aspects, the portal may include mashups and intranet “dashboards.” The portal may use an application programming interface (API). The portal may provide a way for enterprises and organizations with access control, modification, procedures, and the like for multiple applications and databases. The features available may be restricted to an authorized and authenticated user (employee, member).

Voice recognition software may be utilized in various aspects of the systems and methods. Users may be able to vocalize, rather than utilizing other input processes. For example, the voice recognition software may be configured for generating text from voice input from a microphone or other voice input. A speech signal processor may convert speech signals into digital data that can be processed by the processor. The processor may perform several distinct functions, including serving as the speech event analyzer, the dictation event subsystem, the text event subsystem, and the executor of the application program. The speech signal processor may generate speech event data and transmit this data to the processor to be processed first by the speech event analyzer. The speech event analyzer may generate a list or set of possible candidates among the system recordings that represent or match the voice input processed by the speech signal processor. The speech event analyzer may transmit the candidate sets to a dictation event subsystem. The dictation event subsystem may analyze the candidate sets and choose the best match candidate with the highest degree of similarity. This candidate is then considered the correct translation, and the dictation event subsystem forwards the translation to the text event subsystem which in turn inputs the translated text into the device.

Aspects of the disclosure have been described above with reference to the accompanying drawings, in which aspects of the disclosure are shown. It will be appreciated, however, that this disclosure may, however, be embodied in many different forms and should not be construed as limited to the aspects set forth above. Rather, these aspects are provided so that this disclosure will be thorough and complete, and will fully convey the scope of the disclosure to those skilled in the art. Additionally, the various aspects described may be implemented separately. Moreover, one or more the various aspects described may be combined. Like numbers refer to like elements throughout.

It will be understood that, although the terms first, second, etc. are used throughout this specification to describe various elements, these elements should not be limited by these terms. These terms are only used to distinguish one element from another. For example, a first element could be termed a second element, and, similarly, a second element could be termed a first element, without departing from the scope of the disclosure. The term “and/or” includes any and all combinations of one or more of the associated listed items.

The terminology used herein is for the purpose of describing particular aspects only and is not intended to be limiting of the disclosure. As used herein, the singular forms “a,” “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

It will be understood that when an element such as a layer, region or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “top” or “bottom” may be used herein to describe a relationship of one element, layer or region to another element, layer or region as illustrated in the figures. It will be understood that these terms are intended to encompass different orientations of the device in addition to the orientation depicted in the figures.

Aspects of the disclosure are described herein with reference to cross-section illustrations that are schematic illustrations of idealized embodiments (and intermediate structures) of the disclosure. The thickness of layers and regions in the drawings may be exaggerated for clarity. Additionally, variations from the shapes of the illustrations as a result, for example, of manufacturing techniques and/or tolerances, are to be expected.

In the drawings and specification, there have been disclosed typical aspects of the disclosure and, although specific terms are employed, they are used in a generic and descriptive sense only and not for purposes of limitation, the scope of the disclosure being set forth in the following claims.

Aspects of the disclosure may be implemented in any type of computing devices, such as, e.g., a desktop computer, personal computer, a laptop/mobile computer, a personal data assistant (PDA), a mobile phone, a tablet computer, cloud computing device, and the like, with wired/wireless communications capabilities via the communication channels.

Further in accordance with various aspects of the disclosure, the methods described herein are intended for operation with dedicated hardware implementations including, but not limited to, PCs, PDAs, semiconductors, application specific integrated circuits (ASIC), programmable logic arrays, cloud computing devices, and other hardware devices constructed to implement the methods described herein.

It should also be noted that the software implementations of the disclosure as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to email or other self-contained information archive or set of archives is considered a distribution medium equivalent to a tangible storage medium. Accordingly, the disclosure is considered to include a tangible storage medium or distribution medium, as listed herein and including art-recognized equivalents and successor media, in which the software implementations herein are stored.

Additionally, the various aspects of the disclosure may be implemented in a non-generic computer implementation. Moreover, the various aspects of the disclosure set forth herein improve the functioning of the system as is apparent from the disclosure hereof. Furthermore, the various aspects of the disclosure involve computer hardware that it specifically programmed to solve the complex problem addressed by the disclosure. Accordingly, the various aspects of the disclosure improve the functioning of the system overall in its specific implementation to perform the process set forth by the disclosure and as defined by the claims.

While the disclosure has been described in terms of exemplary aspects, those skilled in the art will recognize that the disclosure can be practiced with modifications in the spirit and scope of the appended claims. These examples given above are merely illustrative and are not meant to be an exhaustive list of all possible designs, aspects, applications or modifications of the disclosure. In this regard, the various aspects, features, components, elements, modules, arrangements, circuits, and the like are contemplated to be interchangeable, mixed, matched, combined, and the like. In this regard, the different features of the disclosure are modular and can be mixed and matched with each other.

1. A method for related product identification comprising:
receiving input data that comprises a reference device data input and a parameter input;
determining at least one related product that matches the reference device data input and the parameter input; and
outputting the at least one related product that matches the reference device data input and the parameter input.

2. The method for related product identification according to claim 1 further comprising preparing data for rendering a reference input display for display on a display of a device that comprises a reference device data input portion and a parameter input portion.

3. The method for related product identification according to claim 1 wherein the outputting the at least one related product that matches the reference device data input and the parameter input further comprises displaying a second at least one related product that matches the reference device data input comprising a parameter greater than or less than the parameter input.

4. The method for related product identification according to claim 3 wherein the second at least one related product that matches the reference device data input comprising a parameter greater than or less than the parameter input comprises a next closest match to the reference device data input and the parameter input.

5. The method for related product identification according to claim 1 wherein the outputting the at least one related product that matches the reference device data input and the parameter input further comprises displaying a second at least one related product that has a next closest match to the reference device data input and the parameter input.

6. The method for related product identification according to claim 1 wherein the outputting the at least one related product that matches the reference device data input and the parameter input further comprises displaying a second at least one related product that matches the reference device data input comprising a parameter greater than the parameter input and a third at least one related product that matches the reference device data input comprising a parameter less than the parameter input.

7. The method for related product identification according to claim 1 wherein the determining at least one related product that matches the reference device data input and the parameter input further comprises searching a database utilizing reference device matching criteria to find matching cross-reference device matching criteria to determine the at least one related product.

8. The method for related product identification according to claim 1 wherein the reference device data input comprises at least one of the following: a manufacturer name, a part number, multiple manufacturer names, a device type, and/or multiple part numbers.

9. (canceled)

10. The method for related product identification according to claim 1 wherein the parameter input comprises a plurality of parameter inputs.

11. (canceled)

12. The method for related product identification according to claim 1 wherein the parameter input comprises at least one of the following: a qualification, a drain-source on-state resistance, a drain-source voltage, a maximum drain current, a polarity, a minimum operating temperature, a maximum operating temperature, a pulsed drain current, a DC body diode forward current, a pulsed body diode current, a gate-source voltage, a maximum transient voltage, a recommended turn-off gate voltage, a short-circuit withstand time, a power dissipation, a virtual junction temperature, a storage temperature, a soldering temperature, a body diode thermal resistance, a junction—case, thermal resistance, a body diode forward voltage, a gate-source threshold voltage, a zero gate voltage drain current, a gate-source leakage current, a transconductance, an internal gate resistance, an input capacitance, an output capacitance, a reverse capacitance, a stored energy, a total gate charge, a gate to source charge, a gate to drain charge, a turn-on delay time, a rise time, a turn-off delay time, a fall time, a turn-on energy, a turn-off energy, a total switching energy, a diode reverse recovery charge, a diode peak reverse recovery current, a device resistance, a device capacitance, device resonant points, an inductance, transfer data, a transfer function, data representative of an independent scalar input versus a dependent scalar output, parametric data, a device transfer curve, time domain waveforms, static losses, dynamic losses, and/or a drain-source current.

13. The method for related product identification according to claim 1 wherein the reference device data input comprises at least one of the following: keyed in data, data selection by drop-down boxes, data selection by selection from a list, data selection by a drop-down list, data selection by radio buttons, voice recognition input data, image input data, and/or machine-readable code input data.

14. (canceled)

15. The method for related product identification according to claim 1 wherein the outputting the at least one related product that matches the reference device data input and the parameter input further comprises displaying at least one of the following: a stock-keeping unit (SKU) for the at least one related product, a buy online icon for the at least one related product, a datasheet icon for the at least one related product, and/or a parameter data listing for the at least one related product.

16. The method for related product identification according to claim 2 further comprising implementing at least one processor, wherein:
the at least one processor comprises a processor implemented by a cross-reference system that comprises a database; and
the processor implemented by the cross-reference system connects to the device over a network.

17. The method for related product identification according to claim 2 further comprising implementing at least one processor, wherein the device comprises an internet enabled device that comprises a processor implemented as the at least one processor.

18.-25. (canceled)

26. A method for related product identification comprising:
receiving input data that comprises a reference device data input and a parameter input; and
determining at least one related product that is closest to the reference device data input and the parameter input.

27. The method for related product identification according to claim 26 further comprising preparing data for rendering a reference input display for display on a display of a device that comprises a reference device data input portion and a parameter input portion.

28. The method for related product identification according to claim 26 wherein the determining the at least one related product that is closest to the reference device data input and the parameter input further comprises displaying a second at least one related product that is closest to the reference device data input comprising a parameter greater than or less than the parameter input.

29. The method for related product identification according to claim 28 wherein the second at least one related product that is closest to the reference device data input comprising a parameter greater than or less than the parameter input comprises a next closest to the reference device data input and the parameter input.

30. The method for related product identification according to claim 26 wherein the determining the at least one related product that is closest to the reference device data input and the parameter input further comprises displaying a second at least one related product that is closest to the reference device data input comprising a parameter greater than the parameter input and a third at least one related product that is closest to the reference device data input comprising a parameter less than the parameter input.

31. The method for related product identification according to claim 26 further comprising:
outputting the at least one related product that is closest to the reference device data input and the parameter input; and
displaying a second at least one related product that has a next closest to the reference device data input and the parameter input.

32. The method for related product identification according to claim 27 wherein the determining at least one related product that is closest to the reference device data input and the parameter input further comprises searching a database utilizing reference device matching criteria to find matching cross-reference device matching criteria to determine the at least one related product.

33. The method for related product identification according to claim 26 wherein the reference device data input comprises at least one of the following: a manufacturer name, a part number, multiple manufacturer names, a device type, and/or multiple part numbers.

34. (canceled)

35. The method for related product identification according to claim 26 wherein the parameter input comprises a plurality of parameter inputs.

36. (canceled)

37. The method for related product identification according to claim 26 wherein the parameter input comprises at least one of the following: a qualification, a drain-source on-state resistance, a drain-source voltage, a maximum drain current, a polarity, a minimum operating temperature, a maximum operating temperature, a pulsed drain current, a DC body diode forward current, a pulsed body diode current, a gate-source voltage, a maximum transient voltage, a recommended turn-off gate voltage, a short-circuit withstand time, a power dissipation, a virtual junction temperature, a storage temperature, a soldering temperature, a body diode thermal resistance, a junction—case, thermal resistance, a body diode forward voltage, a gate-source threshold voltage, a zero gate voltage drain current, a gate-source leakage current, a transconductance, an internal gate resistance, an input capacitance, an output capacitance, a reverse capacitance, a stored energy, a total gate charge, a gate to source charge, a gate to drain charge, a turn-on delay time, a rise time, a turn-off delay time, a fall time, a turn-on energy, a turn-off energy, a total switching energy, a diode reverse recovery charge, a diode peak reverse recovery current, a device resistance, a device capacitance, device resonant points, an inductance, transfer data, a transfer function, data representative of an independent scalar input versus a dependent scalar output, parametric data, a device transfer curve, time domain waveforms, static losses, dynamic losses, and/or a drain-source current.

38. The method for related product identification according to claim 26 wherein the reference device data input comprises at least one of the following: keyed in data, data selection by drop-down boxes, data selection by selection from a list, data selection by a drop-down list, data selection by radio buttons, voice recognition input data, image input data, and/or machine-readable code input data.

39. (canceled)

40. The method for related product identification according to claim 26 wherein the determining the at least one related product that is closest to the reference device data input and the parameter input further comprises displaying at least one of the following: a stock-keeping unit (SKU) for the at least one related product, a buy online icon for the at least one related product, a datasheet icon for the at least one related product, and/or a parameter data listing for the at least one related product.

41. The method for related product identification according to claim 27 further comprising implementing at least one processor, wherein:
the at least one processor comprises a processor implemented by a cross-reference system that comprises a database; and
the processor implemented by the cross-reference system connects to the device over a network.

42. The method for related product identification according to claim 27 further comprising implementing at least one processor, wherein the device comprises an internet enabled device that comprises a processor implemented as the at least one processor.

43.-50. (canceled)

51. A system for related product identification comprising:
the system configured to receive a reference device data input and a parameter input;
the system configured to determine at least one related product that matches the reference device data input and the parameter input; and
the system further configured to output the at least one related product that matches the reference device data input and the parameter input.

52.-75. (canceled)

76. A system for related product identification comprising:
a system configured to receive a reference device data input and a parameter input; and
the system configured to determine at least one related product that is closest to the reference device data input and the parameter input.

77.-100. (canceled)
